(19) United States
(12) Patent Application Publication
(10) Pub. No.: US 2005/0039691 A1
(43) Pub. Date: Feb. 24, 2005

(54) Animal nourishment systems and systems that include valve assemblies

(76) Inventors: Joseph M. Jarke, Austin, TX (US); Keith H. Gausmann, Westerville, OH (US); Jeffrey W. Mulhausen, Austin, TX (US); Ben J. Sy, Austin, TX (US)

Correspondence Address: FULBRIGHT & JAWORSKI L.L.P., 600 CONGRESS AVE., SUITE 2400, AUSTIN, TX, 78701, US

(21) Appl. No.: 10/911,964

(22) Filed: Aug. 5, 2004

Related U.S. Application Data
(60) Provisional application No. 60/492,500, filed on Aug. 5, 2003.

(51) Int. Cl. A01K 7/00

(52) U.S. Cl. 119/72

(57) ABSTRACT

A system that includes a valve assembly. One version of the valve assembly includes a housing, a valve stem coupled to the housing, and an axis running through the valve stem. The valve stem includes a section that has a groove that includes a portion oriented at less than 85 degrees to the axis. A nourishment system that includes a nourishment dispenser for animals. One version of the nourishment dispenser includes a body and a fluid level indicator coupled to the body. The fluid level indicator has a first opening, a second opening, and a passageway extending from the first opening to the second opening. Another version of the nourishment dispenser includes a body having a nourishment holding portion and two legs extending from the nourishment holding portion. Other versions of these systems, assemblies and dispensers are included.

### CROSS-REFERENCE(S) TO RELATED APPLICATION(S)

This application claims priority to U.S. Provisional Patent Application Ser. No. 60/492,500, filed Aug. 5, 2003, the entire contents of which are expressly incorporated by reference.

### BACKGROUND OF THE INVENTION

1. Field of the Invention

The invention relates to nourishment systems for animals. More specifically, the invention relates to containers for dispensing nourishing matter, such as water, to animals. The invention also relates to systems that include valve assemblies useful for dispensing nourishing matter, such as water, to animals.

2. Description of Related Art

It is important that pet owners provide their animals with food and fresh water that has not been contaminated by the weather, leaves, dirt or other animals such as birds or rodents, to insure the animal's health and comfort. The use of common food and water trays or dishes does not sufficiently provide the animal with food and water that is protected from the elements. Additionally, most common food and water trays can be easily moved around or turned over by the animals.

Many water dispensers supply pets with water only upon demand, i.e., the animal activates a dispenser to obtain water. Generally, these dispensers are containers that have flow control nozzles that are activated by the animal licking the nozzle. As a result, a ball valve is unseated, allowing water to be dispensed. However, the volume of flow from such nozzles is not always sufficient. Additionally, some demand actuated water dispensers are not designed or constructed to help keep the water in them cool during periods of high ambient temperature.

### SUMMARY OF THE INVENTION

One of the present systems includes a valve assembly that has a housing, a valve stem coupled to the housing, and an axis running through the valve stem. The valve stem has a section that has a groove that includes a portion oriented at an angle of less than 85 degrees to the axis. In another embodiment, the system may also include a nourishment dispenser for animals that includes a body.

One of the present nourishment systems includes a nourishment dispenser for animals that has a body and a fluid level indicator coupled to the body. In this embodiment, the fluid level indicator has a first opening, a second opening, and a passageway extending from the first opening to the second opening. In another embodiment, the nourishment dispenser includes a body having a nourishment holding portion and two legs extending from the nourishment holding portion. In still another embodiment, the nourishment dispenser includes a body having an inner surface, an inner liner coupled to the body and positioned adjacent the inner surface, and a valve assembly coupled to the body and to the inner liner, the valve assembly including a valve stem.

Other embodiments of the present systems, assemblies, and dispensers are disclosed below.

### BRIEF DESCRIPTION OF THE DRAWINGS

The following drawings demonstrate aspects of the present systems, valve assemblies, and nourishment systems and dispensers. They illustrate by way of example and not limitation. Like reference numbers refer to similar elements.

FIG. 1 is a front view of one of the present valve assemblies.

FIG. 2 is a top view of one of a housing of one of the present valve assemblies.

FIG. 3 is a cross-sectional view of a housing of one of the present valve assemblies.

FIG. 4 is a front view of one of the present valve stems.

FIG. 5A is a top view of one of the present valve stems.

FIG. 5B is a partial view of a section of one of the present valve stems.

FIG. 5C is a top view of another of the present valve stems.

FIG. 5D is a top view of still another of the present valve stems.

FIG. 6 is an exploded view showing one way that one of the present valve stems may be combined with other parts prior to use with the housing of one of the present valve assemblies.

FIG. 7A depicts together in cross section the parts shown in FIG. 6.

FIGS. 7B and 7C depict valve stems biased in a sideways fashion.

FIG. 7D is an enlarged view of one gap that forms as a result of the biasing shown in FIGS. 7B and 7C.

FIG. 7E is a view showing a similarity in the sizes of one of the present baffle openings and one of the present valve stem sections.

FIG. 8 is an exploded view of the valve stem assembled as shown in FIGS. 6 and 7 and coupled with more parts, including a housing, in one of the present valve assemblies.

FIG. 9 depicts together in cross section the pieces shown in FIG. 8.

FIG. 10 shows one of the present nourishment systems.

FIG. 11 is a front view of another of the present nourishment systems, which includes one of the present nourishment dispensers and one of the present valve assemblies coupled to the nourishment dispenser.

FIGS. 12A-12F are different views of the body of the nourishment dispenser shown in FIG. 11.

FIGS. 13A-13C are different views of the inner liner of the nourishment dispenser shown in FIG. 11.

FIG. 14 is an exploded view of one of the present fluid level indicators.

FIG. 15 is a perspective view of one of the present foam inserts.

FIG. 16 is a perspective view of the bracket of the nourishment dispenser shown in FIG. 11.

FIGS. 17A-17C are different views of the lid of the nourishment dispenser shown in FIG. 11.

FIG. 18 is an exploded view of components of the nourishment dispenser shown in FIG. 11.

FIGS. 19A and 19B are views of a cover coupled to the body of the nourishment dispenser shown in FIG. 11.

### DESCRIPTION OF ILLUSTRATIVE EMBODIMENTS

In this document (including the claims), the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. Thus, a system or device or an element of a system or device that “comprises,” “has,” “includes,” or “contains” one or more elements possesses those one or more elements, but is not limited to possessing only those one or more elements.

For example, a valve assembly comprising a housing, a valve stem coupled to the housing, and an axis running through the valve stem, the valve stem including a section having a groove that includes a portion oriented at less than 85 degrees to the axis, is a valve assembly that has, but is not limited to only having, the described elements. In other words, the valve assembly possesses at least the listed elements, but can also possess additional elements that are not listed. For example, the valve assembly also covers a gasket configured to fit within the housing. Similarly, the valve assembly also covers a valve stem that has an outwardly projecting shoulder positioned near the section.

Likewise, a valve stem that includes a section having a groove that includes a portion oriented at less than 85 degrees to an axis is a valve stem that has such a section, but is not excluded from possessing different sections, so long as the recited section is satisfied.

The terms “a” and “an” mean one or more than one. The term “another” means at least a second or more. The term “multiple” means two or more. In this document, two things are “coupled” if they are connected to each other either directly or indirectly. The connection may be mechanical or electrical.

Those of skill in the art will appreciate that in the detailed description below, certain well known components and assembly techniques have been omitted so that the present systems, valve assemblies, and nourishment systems and dispensers are not obscured in unnecessary detail.

One embodiment of the present systems includes a valve assembly, such as valve assembly 100 shown generally in FIG. 1. Valve assembly 100 includes housing 10 and valve stem 20, which is coupled to housing 10. Housing 10 includes a first end 12, a second end 14, and an outside surface 16. A logo may be stamped, carved, etched, etc., into outside surface 16, depending on the material from which the housing is made.

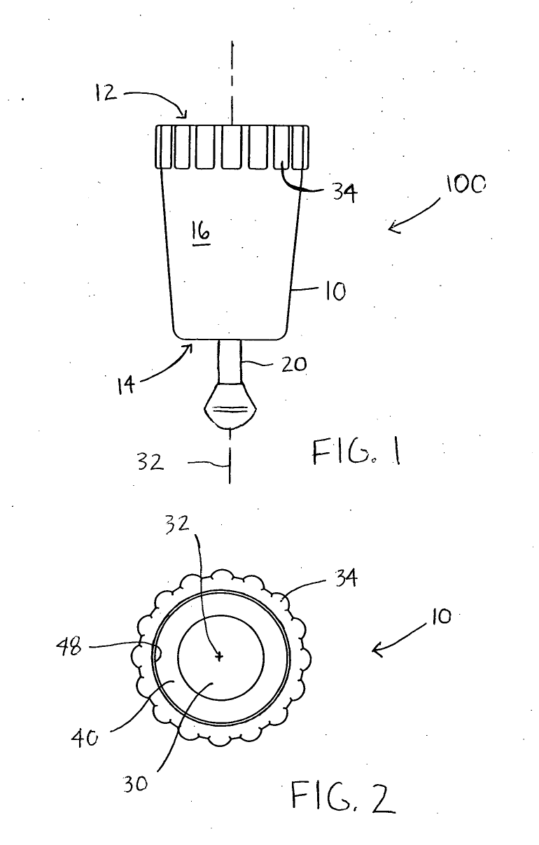

FIG. 2, which depicts housing 10 from the top, shows that housing 10 may also have a passageway 30 and an axis 32 running through passageway 30 (see also FIG. 1 for axis 32) and through valve stem 20. Specifically, axis 32 may be described as being longitudinally centered in housing 10 and/or valve stem 20. “Longitudinally centered” means centered along the length of. As shown in both FIGS. 1 and 2, housing 10 may be provided with gripping ridges 34 positioned around the top portion of the housing near first end 12. Gripping ridges 34 make it easy to grip and rotate housing 10. The shape and number of gripping ridges 34 may vary greatly. FIG. 2 also shows housing shoulder 40, which extends into passageway 30.

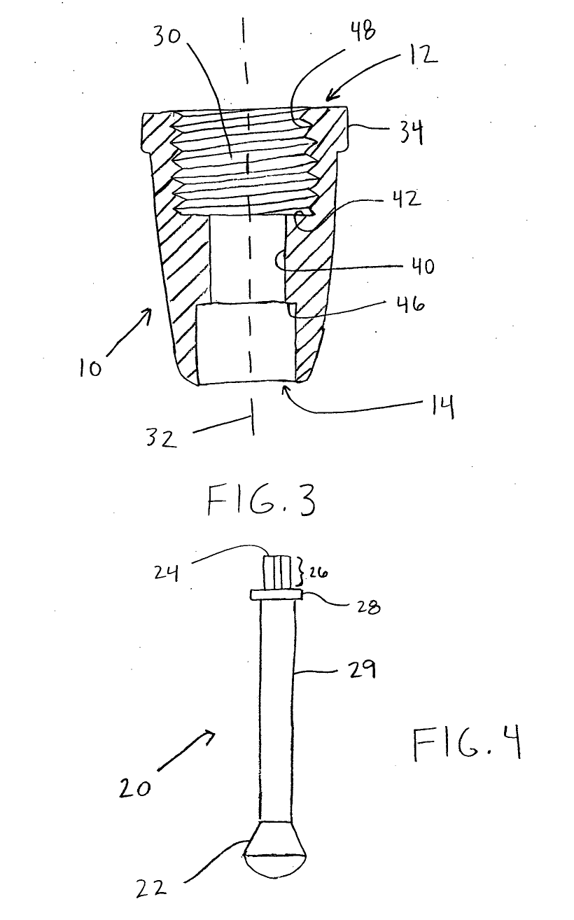

FIG. 3, which depicts a cross-sectional view of housing 10, shows top 42 and bottom 46 of housing shoulder 40, as well as at least one thread 48 positioned between shoulder housing 40 and first end 12. Thread 48 may be any style of thread suited for coupling housing 10 to a male connector. Thread 48 is also visible in FIG. 2. Thread 48 is one way of configuring valve assembly 100 for attachment to a nourishment dispenser that provides nourishment to animals. Valve assembly 100 may be configured in other ways to achieve such attachability.

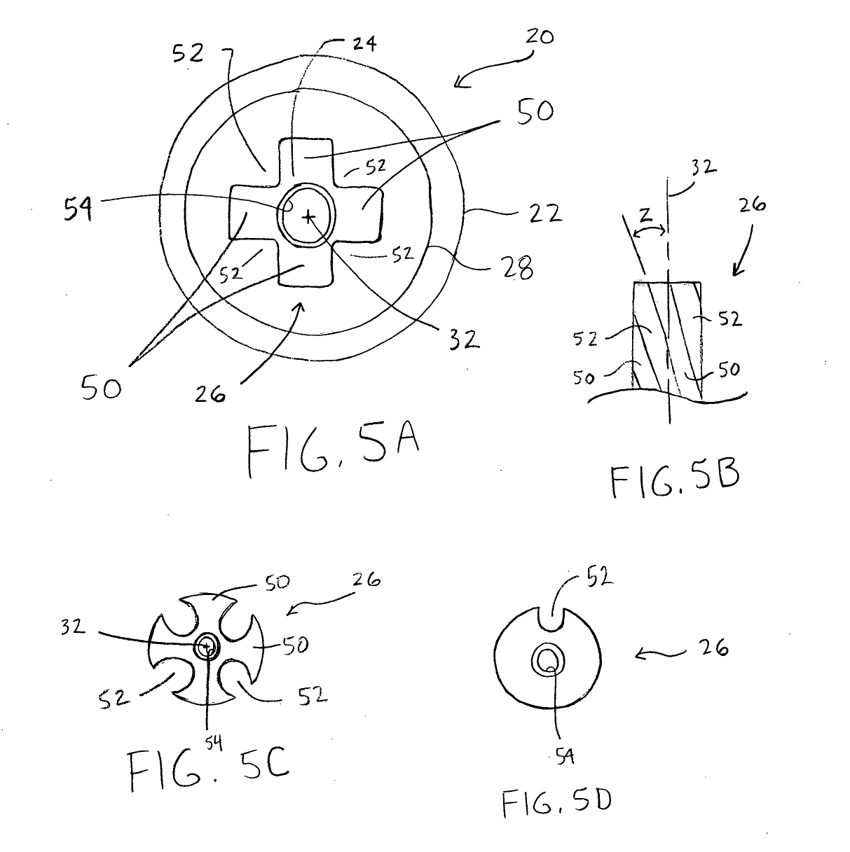

FIG. 4 shows a front view of valve stem 20, which is configured to fit within and be coupled to housing 10. Valve stem 20 has enlarged first end 22, second end 24, and section 26 positioned near second end 24. Adjacent section 26 is collar 28, which is one example of an outwardly projecting shoulder. In the embodiment shown, collar 28 is configured to be wider than (e.g., has a diameter greater than the diameter of) elongated valve stem segment 29, which extends between collar 28 and enlarged first end 22. Valve stem 20 is one example of a valve stem suited for use with the present valve assemblies. Another version of a suitable valve stem for use with the present valve assemblies lacks an enlarged first end. Still another has an elongated valve stem segment that is not uniform in diameter, or that is rectangular when viewed in cross-section.

FIG. 5A is a top view showing an enlarged version of valve stem 20. FIG. 5A shows that section 26 of valve stem 20 (which is a top portion of valve stem 20) includes multiple ridges 50, at least one of which has a portion that is oriented at an angle of less than 85 degrees to axis 32. More specifically, multiple ridges 50 are oriented at an angle of 0 degrees to axis 32 (i.e., multiple ridges 50 run parallel to axis 32 (see also FIG. 4)). Adjacent ridges 50 define grooves 52 between them. Thus, section 26 of valve stem 20 (which is a top portion of valve stem 20) includes at least one groove 52. More specifically, section 26 of valve stem 20 includes at least one groove 52 that includes a portion that is oriented at an angle of less than 85 degrees to axis 32. Even more specifically, section 26 includes multiple grooves, at least one of which (and, more specifically, each of which) includes a portion that is oriented at an angle of less than 85 degrees to axis 32. As shown in FIG. 5A, grooves 52 are oriented at an angle of 0 degrees to axis 32 (i.e., multiple grooves 52 run parallel to axis 32). Section 26 of valve stem 20 may be formed integrally with the remainder of valve stem 20, or it may be a separate piece that is coupled to the remainder of valve stem 20.

FIG. 5B shows an example of section 26 in which both grooves 52 and ridges 50 include a portion that is oriented at angle of Z degrees to axis 32. Angle Z is less than 85 degrees, and may be less than 84, 83, 82, 81, 80, 79, 78, 77, 76, 75, 74, 73, 72, 71, 70, 69, 68, 67, 66, 65, 64, 63, 62, 61, 60, 59, 58, 57, 56, 55, 54, 53, 52, 51, 50, 49, 48, 47, 46, 45, 44, 43, 42, 41, 40, 39, 38, 37, 36, 35, 34, 33, 32, 31, 30, 29, 28, 27, 26, 25, 24, 23, 22, 21, 20, 19, 18, 17, 16, 15, 14, 13, 12, 11, 10,9, 8, 7,6, 5,4, 3,2, 1, 0, or any increment of a degree derivable from one of these degrees, so long as the increment is less than 85 degrees. In the present figures, the portion oriented at an angle of less than 85 degrees is always the entire ridge or groove in question. However, although not shown, only part of a particular groove or ridge need be oriented in this fashion.

Although four ridges are shown in FIG. 5A, as few as two ridges or as many as are needed to achieve the desired flow rate through one of the present valve assemblies may be used as described above. Thus, 2, 3, 4, 5, 6, 7, 8, 9, 10, or more ridges can be used. FIG. 5A also shows that valve stem 20 may have a threaded recess 54 (e.g., a female recess provided with any suitable thread or threads) that extends from second end 24 into valve stem 20 and toward first end 22. The present ridges could be shaped differently than as shown in FIG. 5A. For example, the ridges could be shaped as shown in FIG. 5C (remainder of valve stem 20 not shown). “Ridges” are raised portions.

As yet another alternative, one or more grooves may be provided in a section of valve stem 20 without any ridges, as shown in FIG. 5D. There, only one groove is shown, but 2, 3, 4, 5, 6, 6, 7, 8, 9, 10, or more grooves may be provided in valve stem 20 as needed to achieve the desired flow rate through one of the present valve assemblies.

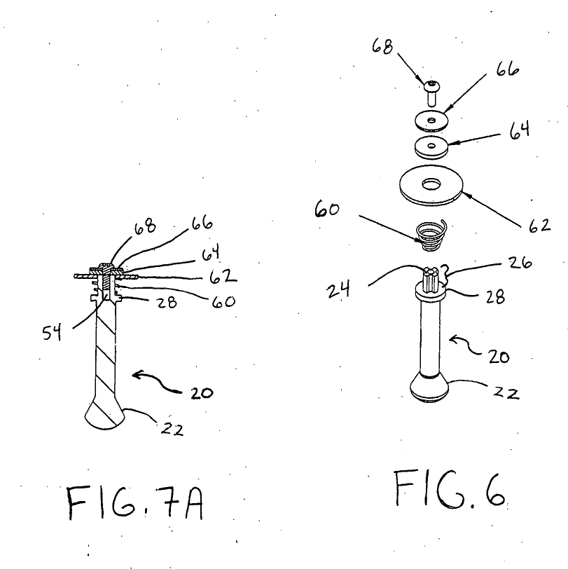

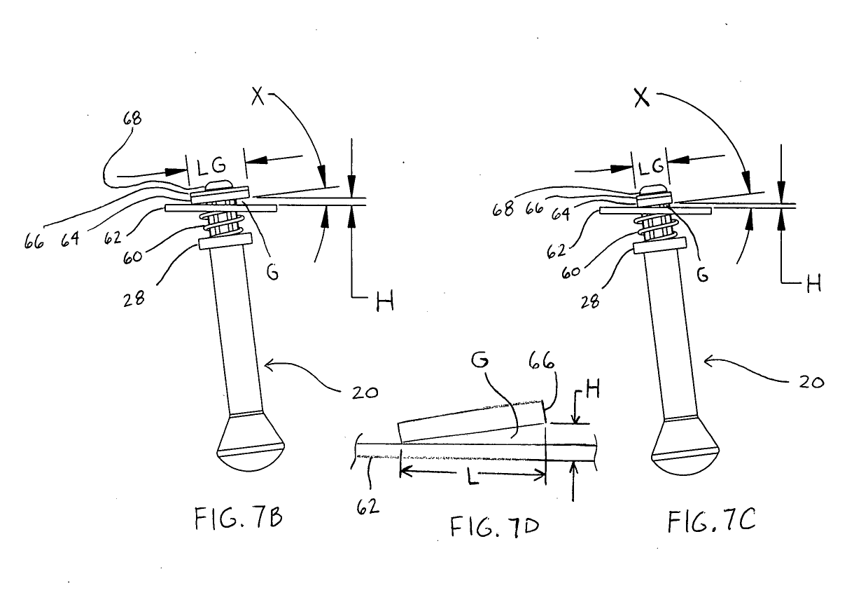

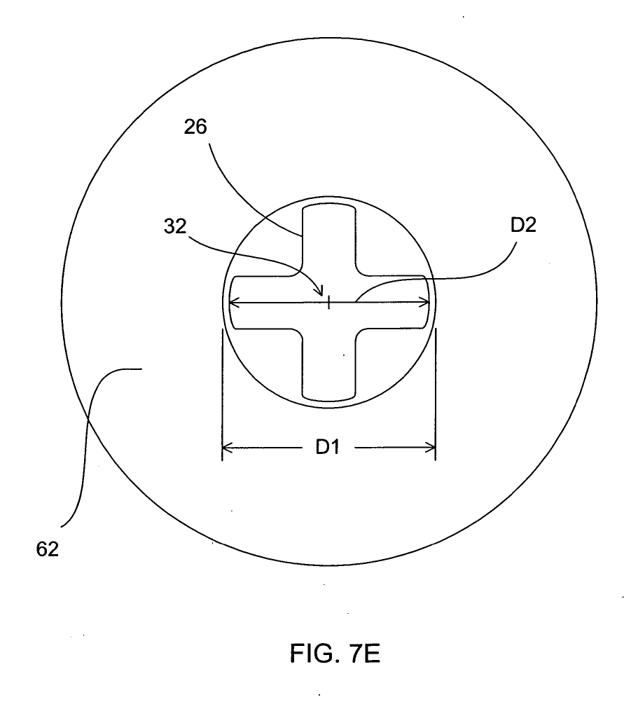

FIG. 6 is an exploded view showing one way that valve stem 20 may be combined with other parts prior to use with housing 10 in a valve assembly. FIG. 6 shows that spring 60 (which is one example of a biasing structure positioned near a baffle such as housing shoulder washer 62, discussed below) may be configured for placement over section 26 (e.g., a portion) of valve stem 20 such that spring 60 contacts the top of collar 28 when placed in that fashion. Housing shoulder washer 62 (which is one example of a baffle having an opening that is configured to fit over a portion—such as section 26—of valve 20) may be configured for placement over section 26 and against spring 60. Screw gasket 64 may be configured for placement against second end 24 of valve stem 20, screw washer 66 may be configured for placement against screw gasket 64, and screw 68 may be provided with one or more external threads and configured for placement through the openings in screw washer 66 and screw gasket 64 and into threaded recess 54, securing both screw washer 66 and screw gasket 64 to valve stem 20 as a result. FIG. 7A depicts together in cross section the parts shown in FIG. 6. Screw gasket 64 is one example of a structure positioned near a baffle (e.g., housing shoulder washer 62) and oriented in a fixed position with respect to valve stem 20, that position being substantially perpendicular to valve stem 20.

The term “substantially” is defined as closely approaching a given state (e.g., preferably within 10% of, more preferably within 1% of, and most preferably within 0.5% of). “Substantially” perpendicular includes perpendicular.

FIGS. 7B and 7C demonstrate the effects of biasing valve stem 20 in a sideways fashion. Both of these figures illustrate aspects of valve assembly 100—valve stem 20, a baffle (e.g., housing shoulder washer 62) having an opening that is configured to fit over a portion of valve stem 20 (e.g., the top portion that includes the ridges and grooves that each have a portion oriented an angle of less than 85 degrees to an axis (not shown) running through valve stem 20); and a structure (e.g., gasket 64) positioned near the baffle and oriented in a fixed position with respect to valve stem 20 that is substantially perpendicular to valve stem 20 (or, more specifically, to the axis running through valve stem 20). Also shown is a biasing structure (e.g., spring 60) positioned near housing shoulder washer 62; screw washer 66; and screw 68. The housing of each valve assembly is not shown for clarity.

These two figures show that when valve stem 20 is biased by X degrees in a sideways fashion, gasket 64 is positioned such that it contacts housing shoulder washer 62, forming gap G between the bottom surface of gasket 64 and the top surface of housing shoulder washer 62. While those two surfaces are flat in this embodiment, in other embodiments, they may be non-flat (e.g., curved or otherwise defined by a non-straight line). As shown in FIG. 7D, which is an enlarged partial view of certain aspects of valve assembly 100 that concern gap G (many details omitted for clarity), gap G has a length L. Gap G also has a height H (see FIGS. 7B-D) that, as shown in this embodiment, varies along the length of the gap.

Biasing a valve stem in a “sideways fashion” means to bias the valve in any way that will cause the valve stem to pivot like a pendulum. To achieve this, the biasing cannot be only axial (as can be done to actuate the valve stem on, for example, a car tire) and it cannot displace the valve stem only laterally (i.e., shift it to the side without causing it to tilt like a pendulum to some extent). There may be elements of both the axial biasing and the lateral shifting in biasing one the present valve stems in a “sideways fashion,” but there must also be an element of causing the valve stem to pivot like a pendulum. The result of the biasing will be that the valve stem pivots to some degree like a pendulum, as shown in FIGS. 7B and 7C, resulting in the formation of angle X.

In the embodiment shown in FIGS. 7B-7D, one manner of calculating the value of the height of gap G at its greatest portion (e.g., the point of height H along length L where the value of H is the largest) is by multiplying the sin of angle X by the length LG of gasket 64. This calculation is possible because the bottom surface of gasket 64 and the top surface of housing shoulder washer 62 are flat, and assumes that gasket 64 (which may be made of rubber) does not deform (e.g., compress) when gap G is formed. In one embodiment, where length LG is 0.7 centimeters (cm), and angle X is 1 degree, the height of gap G at its greatest portion is at least 0.012 cm. When angle X is increased to 7 degrees in this embodiment, the height of gap G at its greatest portion increases to 0.085 cm. In another embodiment, where LG is 0.8 cm and angle X is 1 degree, the height of gap G at its greatest portion is at least 0.017 cm. When angle X is increased to 7 degrees in this embodiment, the height of gap G at its greatest portion increases to 0.12 cm. In another embodiment, where LG is 1.4 cm and angle X is 1 degree, the height of gap G at its greatest portion is at least 0.024 cm. When angle X is increased to 7 degrees in this embodiment, the height of gap G at its greatest portion increases to 0.17 cm.

Should gasket 64 compress, or should either of those two surfaces not be flat, any portion of gap G along length L may be measured using traditional methods, such as by using a caliper or a micrometer.

As the length LG of the structure (e.g., gasket 64) positioned near the baffle and oriented in a fixed position with respect to valve stem 20 that is substantially perpendicular to valve stem 20 (or, more specifically, to the axis running through valve stem 20) increases, so does the maximum height and the length L of gap G. This is clear from comparing FIG. 7C to FIG. 7B. This change in the shape of gap G affects the volume of water that can flow through the opening in the baffle (e.g., housing shoulder washer 62) and around the portion of valve stem 20 (e.g., section 26) positioned in that opening. As a baffle, housing shoulder washer 62 can be configured to fill the space within housing 10 (not shown) so as to preclude water from flowing except through the opening in the baffle. Gasket 64, by being position near (and, more specifically, against) housing shoulder washer 62 when the valve stem is in an unbiased position, covers the opening in housing shoulder washer 62, preventing any water from flowing through that opening (and around the structure partially filling the space created by the opening).

When the valve stem is biased in a sideways fashion, gap G is created and water is permitted to flow into gap G and through the space between the opening of housing shoulder washer 62 and a portion of valve stem 20 (e.g., section 26) and out through the housing. By positioning gasket 64 so that it is oriented in a fixed position (with respect to the valve stem) that is substantially perpendicular to the valve stem, the position of gasket 64 will not change with respect to valve stem 20 when the valve stem is biased in a sideways fashion, as shown in FIGS. 7B and 7C. As a result, flow through the valve assembly is predictable. By contrast, were gasket 64 not fixed in its relation to valve stem 20 so that it remained substantially perpendicular to valve stem 20 when the valve stem was biased in a sideways fashion, the formation of the gap might be uncertain and the flow through the opening of the housing shoulder washer and around the portion of the valve stem in that opening might be unpredictable.

Another feature that can be used with the present valve assemblies to increase the predictability of the flow is to make the size of the opening in the baffle (e.g., shoulder washer 62) as similar as possible to the size of the section, or portion, of the valve stem that fits within that opening. That similarity in sizes could be achieved in a number of different ways. One way is through complimentary configurations (e.g., both the opening in the baffle and the referenced section of the valve stem have the same shape, and the sizes of those shapes are very similar). Alternatively, the distances along comparable lines of both the baffle opening and the referenced section can be similar. For example, FIG. 7E shows an example of how distance D1—which, in this particular embodiment, is the diameter of the opening in shoulder washer 62—and distance D2—which is the distance across the widest portion of the embodiment of section 26 shown in the figure—are similar in length. Both distances are taken along the same line, which runs through the center of the valve stem (e.g., axis 32). This similarity helps to stabilize the flow rate through the valve assembly and make it predictable because the valve stem is restricted from shifting very far laterally when the valve stem is biased.

Different configurations for the baffle and the structure positioned near the baffle are possible. For example, the baffle could be built into housing 10 rather than being a separate washer. Additionally, the structure, instead of taking the form of a traditional gasket, could be the head of a screw made from an appropriate material (or even metal if the user were not concerned with completely eliminating flow through the valve assembly when the valve stem is in the unbiased position). As another example, the valve stem could be a unitary piece of material that included a flange or shoulder at or near its top that operated as the structure. The structure could also be screw washer 66 if the user were not concerned with completely eliminating flow through the valve assembly when the valve stem is in the unbiased position. The structure could be made in any suitable fashion provided it was (a) in one embodiment, positioned near the baffle and oriented in a fixed position with respect to the valve stem that is substantially perpendicular to the valve stem, or (b) in another embodiment, positioned such that when the valve stem is biased in a sideways fashion, the baffle contacts the structure and gap G is formed, a portion of the height of which has a value as prescribed above.

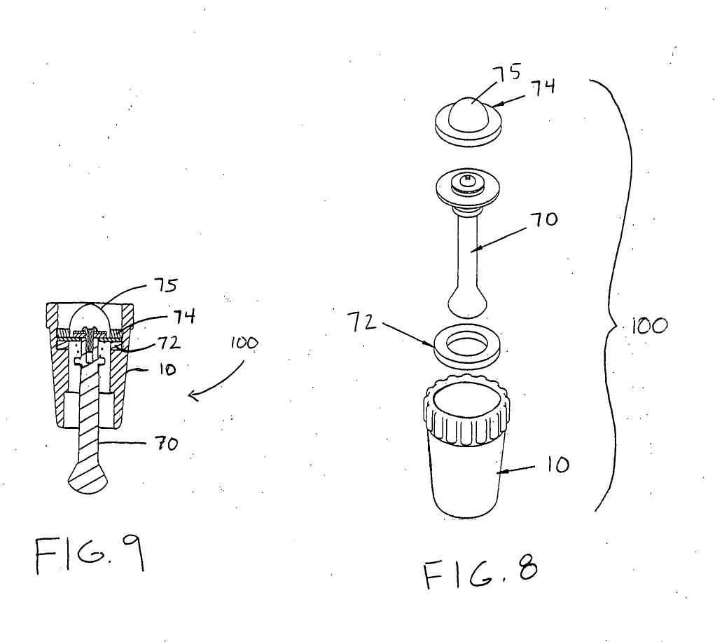

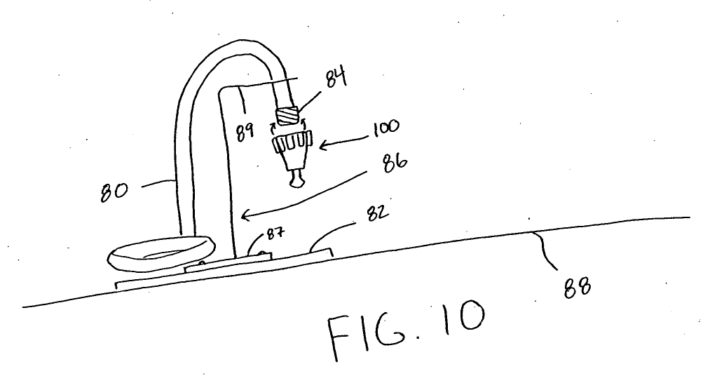

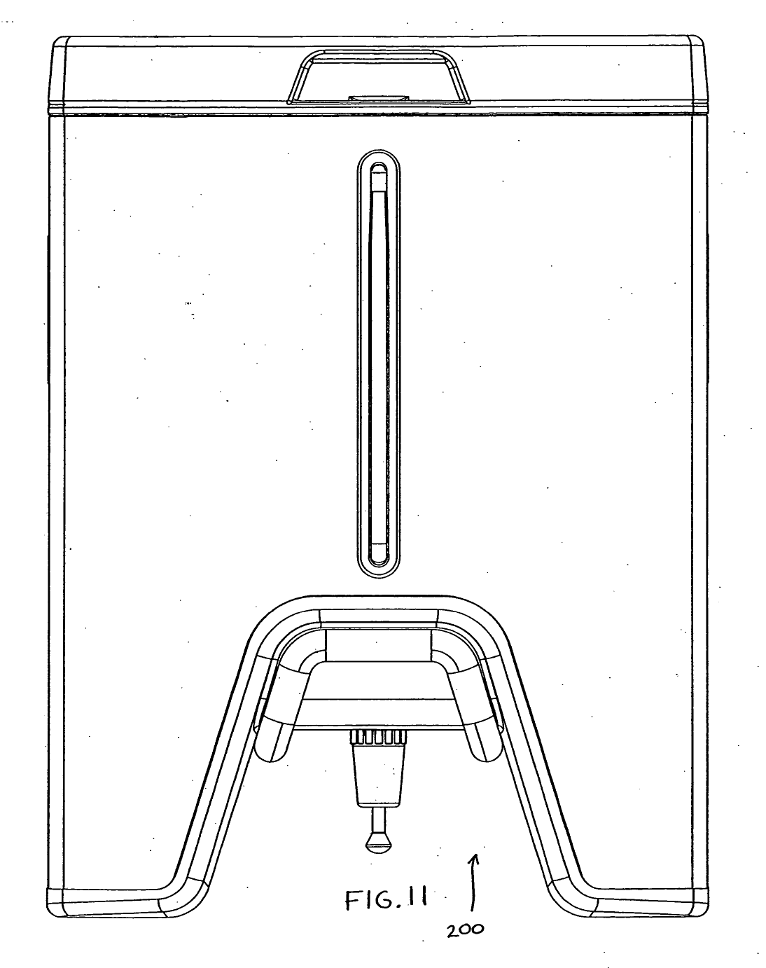

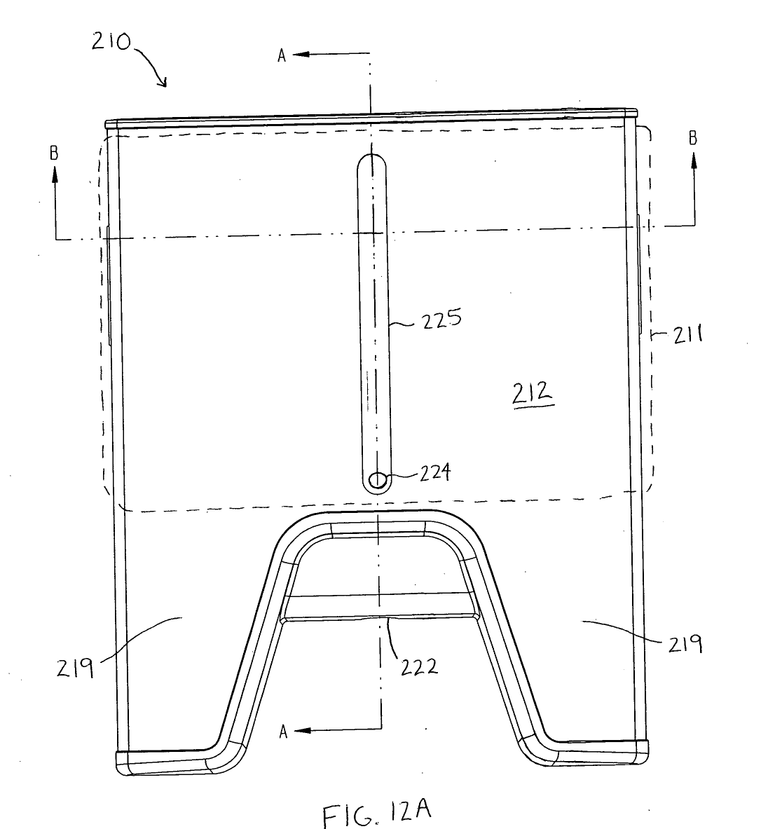

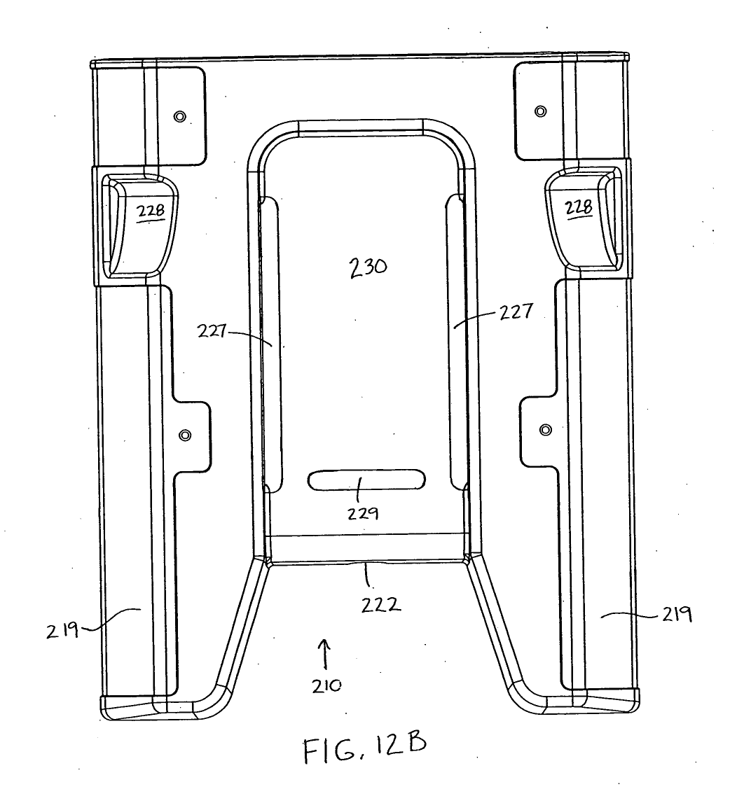

FIG. 8 is an exploded view of valve stem 20 assembled as shown in FIGS. 6 and 7 and coupled with more parts, including housing 10, in valve assembly 100. Specifically, FIG. 8 shows valve assembly sub-unit 70, which comprises the parts shown in FIG. 7, positioned between housing shoulder gasket 72 and gasket 74, which has screen 75 (the holes in screen 75 are not shown). FIG. 9 depicts together in cross section the pieces shown in FIG. 8.

Those of skill in the art will know of many different materials and methods that may be used for making the present valve assemblies. The valve stems and housings may be made from materials such as zinc, aluminum, stainless steel, titanium, nickel, or alloys containing one or more of these metals. These parts may be formed, for example, through casting or through machining solid blocks of material. These materials may also be coated to improve their resistance to corrosion and wear. Any coating material that prevents water corrosion and is non-toxic may be used in this regard. The remaining parts of the exemplary valve assembly shown, for example, in FIGS. 6-9 are off-the-shelf components.

The present valve assemblies, including the valve assembly shown, for example, in FIG. 1, may be coupled to any nourishment dispenser suitable for delivering nourishment to animals. All nourishment dispensers that are configured to be coupled to the present valve assemblies may be used to achieve one of the present systems, which may also be one of the present nourishment systems.

One nourishment dispenser suitable for use with the present systems is a simple water hose. FIG. 10 shows one example of a nourishment dispenser in the form of hose 80 secured to surface 82 (which may be concrete, wood, plastic, earth, etc.) by nourishment dispenser holder 86. As shown, hose 80 may have an end that is configured to be coupled to valve assembly 100. This configuration may be accomplished by providing at least one thread on end 84 of hose 80. Valve assembly 100 may be provided with at least one thread (as shown in FIG. 3) configured to mate with the at least one thread on end 84 of hose 80, such that valve assembly 100 and hose 80 may be coupled to each other (as indicated by the arrows in FIG. 10). Nourishment dispenser holder 86 in FIG. 10 may be secured to surface 82 using any suitable means, such as bolts, adhesive, welding, etc., depending on the materials from which the holder and surface are made. In FIG. 10, surface 82 takes the form of a patio block resting on ground 88, and nourishment dispenser holder 86 takes the form of a stand with base 87 that is bolted to the patio block, and arm 89 extending out of base 87 and holding hose 80.

Another suitable nourishment dispenser is shown in FIG. 11 as nourishment dispenser 200. FIGS. 11-19B were created using Pro/ENGINEER® software (version 2001). As a result, some of these drawings include many lines (some of them light) that are known in the art as “tangent” lines. Those of skill in the art will understand that not all of those tangent lines represent a “hard” change of angle. Instead, they may show where a rounded section meets a flat, or straight, section. We may submit formal drawings during the patent prosecution process that do not include such lines.

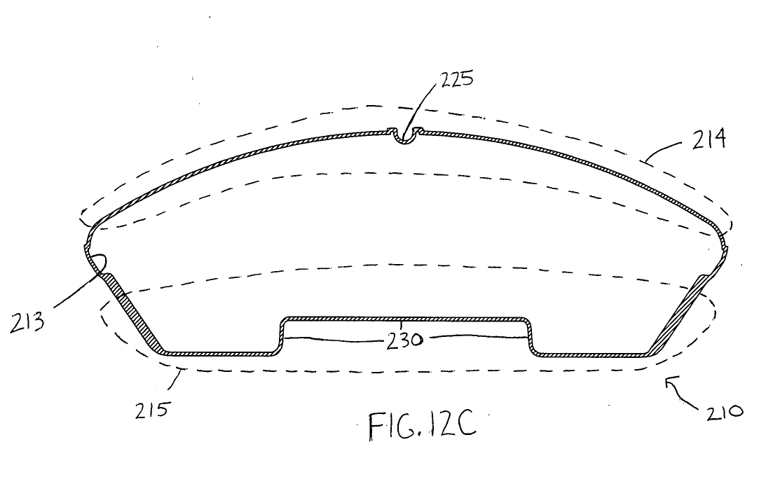

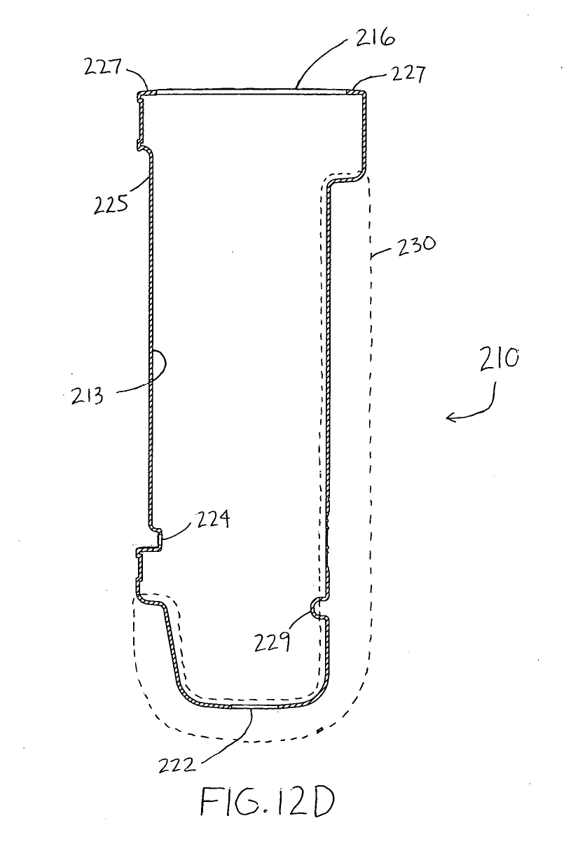

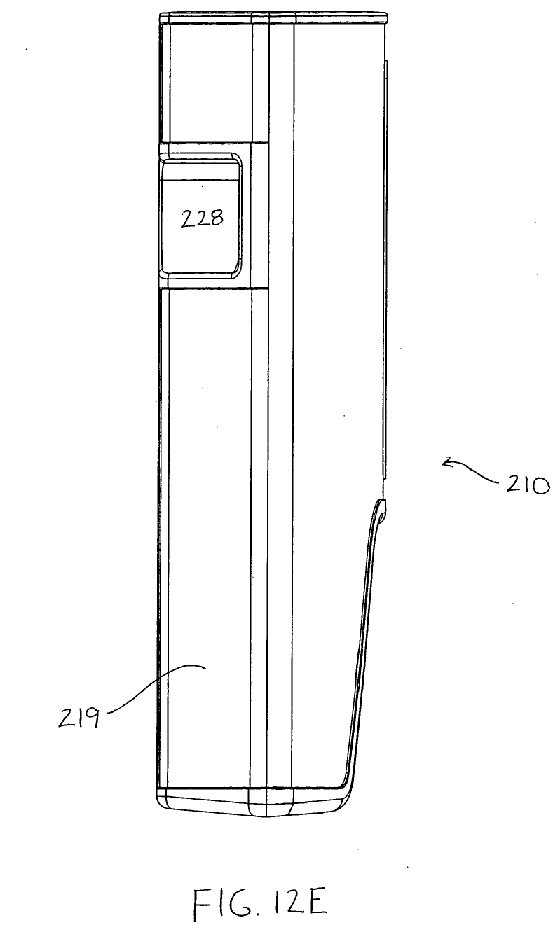

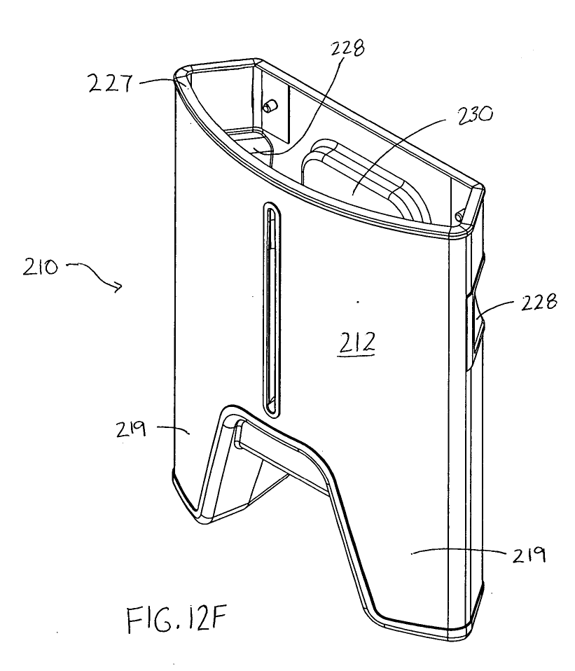

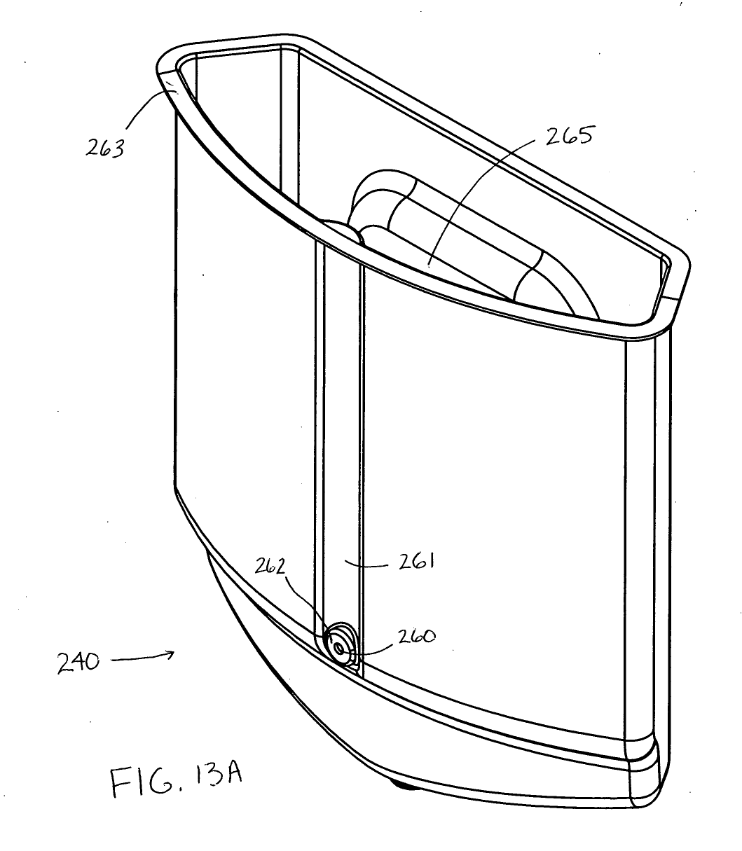

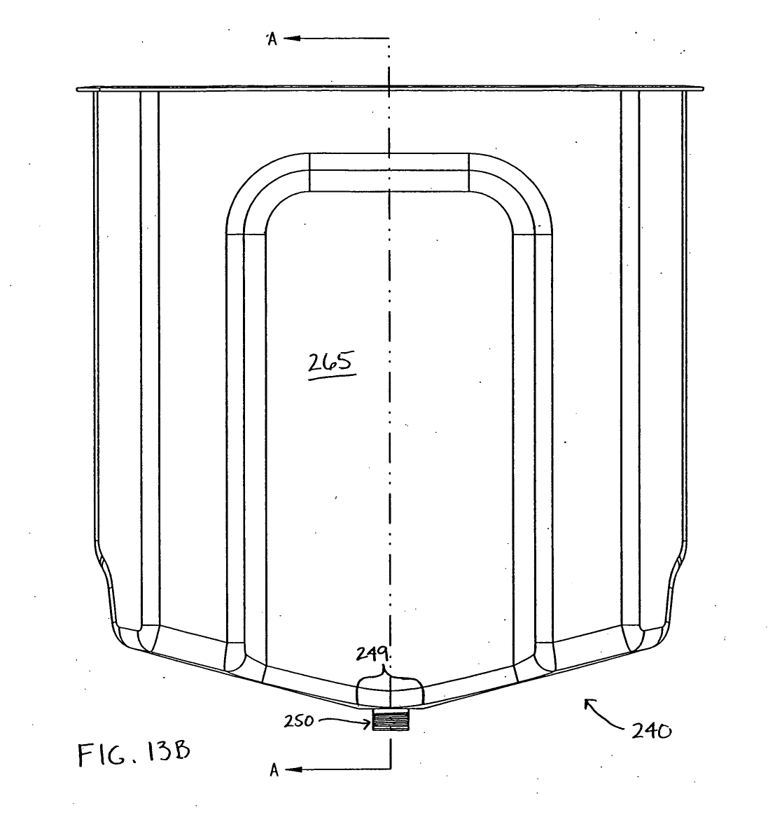

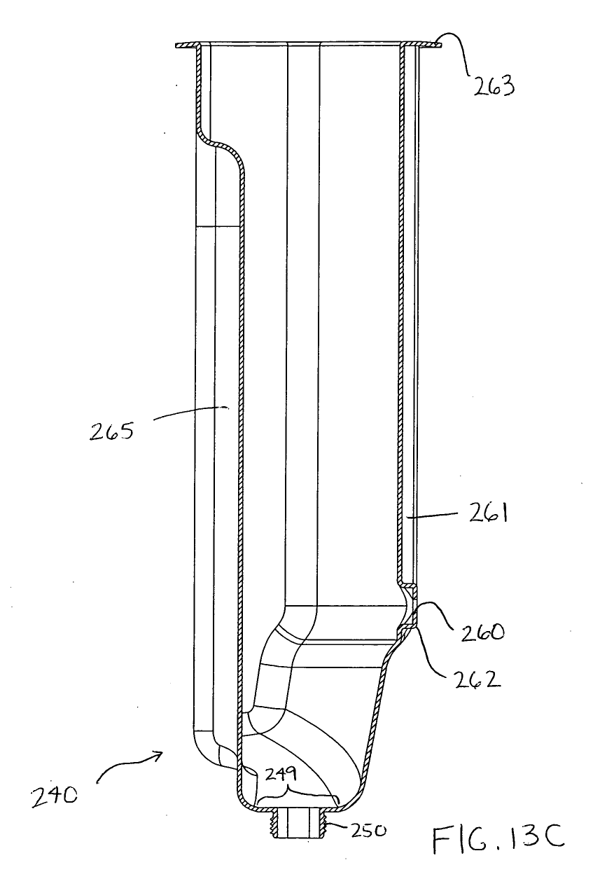

One part of nourishment dispenser 200 is body 210, shown in FIGS. 12A-12F. FIG. 12A is a front view of body 210, and shows outer surface 212, nourishment holding portion 211 outlined generally in dashed lines, and bottom legs 219 (also described as simply legs) extending from nourishment holding portion 211. Nourishment holding portion 211 is generally the portion of body 210 within which nourishment (e.g., water or, more particularly, water with added nutrients, supplements, or therapeutic agents such as drugs) may be held, either directly (e.g., against the interior of body 210 in appropriate circumstances) or indirectly (e.g., within an inner liner positioned inside body 210 and discussed in more detail below). Body 210 also includes body valve assembly opening 222 that is configured to receive a valve assembly, such as valve assembly 100 shown in FIG. 1. More particularly, body valve assembly opening 222 is configured to receive the housing of one of the present valve assemblies, such as housing 10. FIG. 12A also shows that body 210 may include a body fluid level indicator opening 224 and a body fluid level indicator recess 225.

FIG. 12B is a view of the back of body 210 and shows other optional features of body 210. FIG. 12B shows that body 210 may have grip portions 228, which are basically indentions in body 210 that make body 210 easier to pick up and handle. FIG. 12B shows that body 210 may have a bracket recess, such as bracket recess 230. Body 210 may also have vertically-oriented foam holding recesses 227 and horizontally-oriented foam holding recess 229, both of which may serve to hold in place one or more foam inserts, described below in greater detail.

FIG. 12C is a cross-sectional view of a top portion of body 210, taken along line B-B in FIG. 12A. FIG. 12C shows front portion 214 of body 210 (designated generally by dashed lines) and back portion 215 of body 210 (also designated generally by dashed lines). The top of body 210 is open. FIG. 12C also shows inner surface 213 of body 210.

FIG. 12D is a cross-sectional view of body 210 taken along line A-A in FIG. 12A. FIG. 12D shows that body 210 includes opening 216 at its top. This figure also shows that recess 230 may extend from the back of body 210 around a portion of the bottom of body 210 to the front of body 210, as shown generally by dashed lines. FIG. 12D also shows that body 210 may be provided with a top lip 227 adjacent opening 216. The inner liner discussed below may also include a top lip that rests against top lip 227 and prevents the inner liner from sliding into the interior of body 210.

FIG. 12E is a left side view of body 210, the right side view being identical. FIG. 12F is a perspective view of body 210, showing the top, front, and right side.

Body 210 may be made from many different materials. Desirable characteristics of such materials include rigidity, lightness in weight, and durability. Synthetics such as high density polyethylene (HDPE) may be used for body 210. In addition, such materials may be molded, such as by blow molding, injection molding, compression molding, pressure forming, and roto molding. Synthetics with the named desirable characteristics and that can be formed using any of these techniques may also be used for body 210. Body 210 may have any suitable thickness. Moreover, various portions of body 210 may have different thicknesses.

Nourishment dispenser 200 may also include an inner liner that is configured to hold nourishment such as fluid and, more particularly, water. FIGS. 13A-D show one example of a such an inner liner at element 240. FIG. 13A is a perspective view of inner liner 240, which shows the front, top, and right side. Inner liner 240 may include inner liner fluid level indicator opening 260 configured to receive a fluid level indicator or, more particularly, a male projection of a fluid level indicator. Inner liner 240 may also have an inner liner fluid level indicator recess 261. Inner liner 240 may have raised portion 262 bordering inner liner fluid level indicator opening 260, which may have at least one thread (not shown). Inner liner 240 may also include a lip 263 that is configured to rest against top lip 227 of body 210. Inner liner 240 may also be provided with inner liner bracket recess 265, which may be configured to compliment bracket recess 230 of body 210, such that the two fit together when inner liner 240 is coupled to body 210.

Because inner liner 240 may be configured to hold nourishment, its bottom portion may be configured to slope downwardly on both sides, as shown in FIG. 13B, which shows the back of inner liner 240. A male projection, such as valve assembly male fitting 250, may be provided at the bottom of inner liner 240. This male fitting may be provided with at least one external thread (of any suitable style) such that male fitting 250 is configured to be coupled to a valve assembly configured with a complementary female thread, such as thread 248 of housing 10. A bottom portion of inner liner 240 may be configured with a flat portion 249 that is configured, or shaped, so that it fits against a flat portion of body 210 surrounding body valve assembly opening 222 of body 210.

FIG. 13C is a cross-sectional view of inner liner 240 taken along line A-A in FIG. 13B.

Like body 210, inner liner 240 may have any suitable thickness. Moreover, various portions of inner liner 240 may have different thicknesses. Inner liner 240 may be made from any of the same materials that may be used to form body 210. Further, the manner in which those materials may be made include the same manufacturing processes described above with respect to body 210.

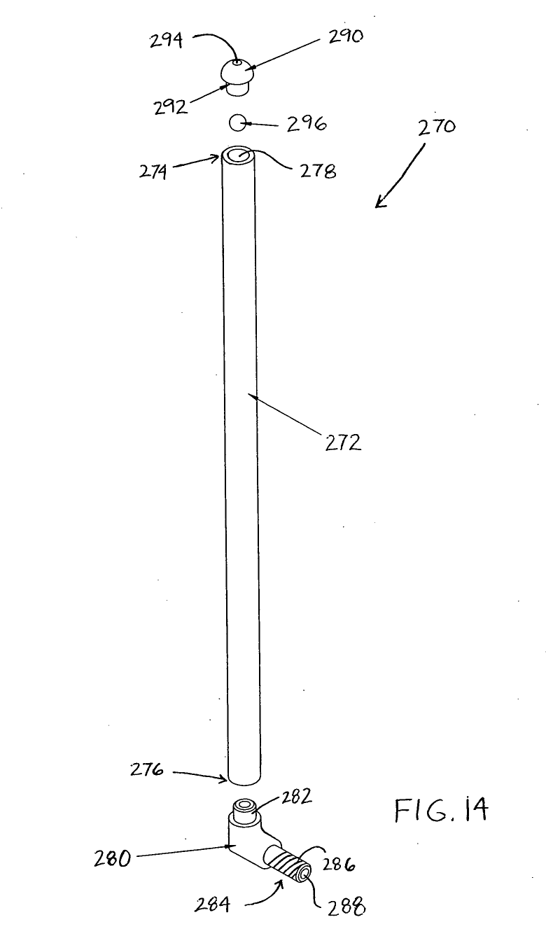

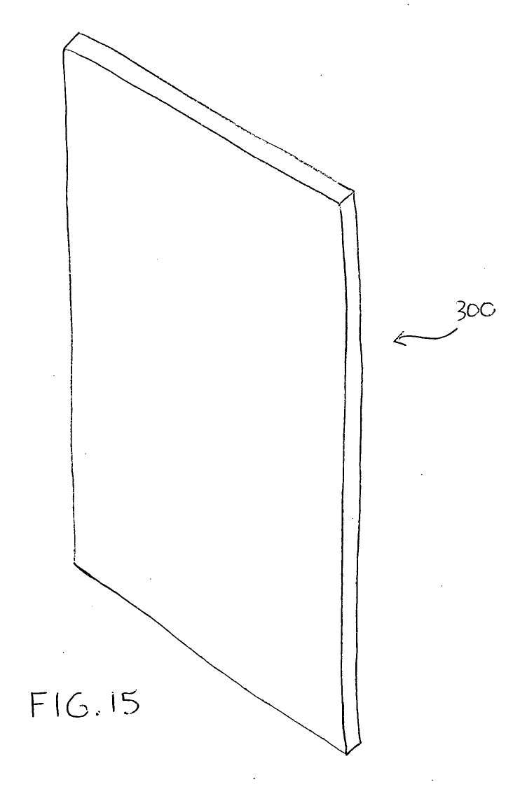

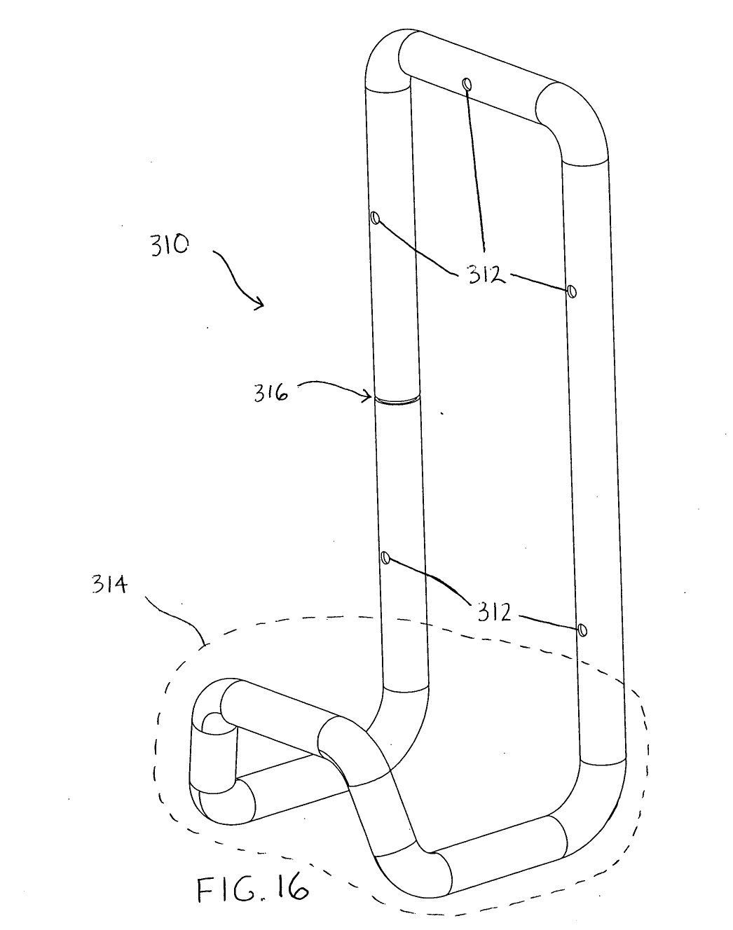

Inner liner 240 may hold fluids, such as water, for consumption by animals. More specifically, when a valve assembly, such as valve assembly 100 shown in FIG. 1, is coupled to valve assembly male fitting 250, and a fluid level indicator is coupled to the inner liner (e.g., at fluid level indicator opening 260), inner liner 240 may be substantially liquid tight (which may include complete liquid tightness) except for the top opening. As a result, water or any other nourishing fluid may be placed inside inner liner 240 for dispensing to animals through the coupled valve assembly. A fluid level indicator, such as the one shown in FIG. 14, may be coupled to inner liner 240 to indicate the level of the water (or other fluid).

Turning then to FIG. 14, an example of a fluid level indicator suited for use with nourishment dispenser 200 is shown in exploded fashion. Fluid level indicator 270 includes main segment 272, which includes first end 274, second end 276, and passageway 278. Configured for insertion into passageway 278 at second end 276 is inner liner interface 280. Inner liner interface 280 includes upper fitting projection 282, which is configured to fit within passageway 278 at second end 276, and lower fitting projection 284. Lower fitting projection 284 may be provided with at least one male thread 286. Inner liner interface 280 may also include passageway 288 that extends from lower fitting projection 284 to upper fitting projection 282. Further, passageway 288 extends from the opening in first end 274 to the opening in second end 276. Fluid level indicator may also include cap 290, which includes main segment fitting 292 and passageway 294, and fluid level indicator marker 296.

In use, inner liner interface 280 may be coupled to inner liner 240 by inserting lower fitting projection 284 inner liner fluid level indicator opening 260 of inner liner 240 such that a portion of lower fitting projection 284 extends into the interior of inner liner 240 and attaching a threaded nut to lower fitting projection 284 (without or without a washer and/or gasket). Thus, a threaded nut may be used to couple fluid level indicator 270 to inner liner 240. Alternatively, inner liner fluid level indicator opening 260 of inner liner 240 may be provided with a female thread to which male thread 286 may be coupled. Next, main segment 272 may be joined to inner liner interface 280 by placing the portion of passageway 278 near second end 276 over upper fitting projection 282 and securing the two together through any suitable means depending on the material used. When inner liner 240 is coupled to body 210 (such as by placing inner liner 240 into body 210 and coupling a valve assembly (e.g., valve assembly 100) to valve assembly male fitting 250 of inner liner 240), the coupling of fluid level indicator 270 to inner liner 240 also couples fluid level indicator 270 to body 210.

If a synthetic material, such as a plastic is used for fluid level indicator 270, then heat or a suitable adhesive may be used to join main segment 272 to inner liner interface 280. Similarly, an adhesive may also be used to reinforce the connection between inner liner interface 280 and fluid level indicator opening 260 in inner liner 240. Alternatively, a threaded connection (that may be reinforced with an adhesive) may be used to join main segment 272 and inner liner interface 280. Fluid level indicator marker 296, which may take the form of a lightweight colored (e.g., red) synthetic ball, may be dropped into passageway 278. Cap 290 may then be attached to main segment 272 by placing main segment fitting 290 into the portion of passageway 278 near first end 274 and securing the two together through any suitable means depending on the material used, such as through threads (which may have adhesive applied to them), heat, or any suitable adhesive, depending on the material used.

Once the attachments have been made and fluid level indicator 270 is put together, the passageways of the various pieces communicate with one another. Moreover, the passageways, which may be thought of as one passageway (considering, for example, that all of the pieces could simply be made from one piece that did not require assembly), communicate with the space inside inner liner 240 and with the space outside of the fluid level indicator. In this way, the level of the fluid in inner liner 240 will be indicated by the bottom of fluid level indicator marker 296 in fluid level indicator 270. Passageway 294 in cap 290 may be made small enough so that fluid level indicator marker 296 cannot pass through it.

The pieces of fluid level indicator 270 may be made from many different materials. Desirable characteristics of such materials include rigidity, lightness in weight, and durability. A suitable material may also be transparent, translucent, or transmitting of light. Synthetics such as polycarbonate (e.g., clear polycarbonate), acrylic, or clear ABS may be used for fluid level indicator 270. In addition, such materials may be molded, such as by injection molding. Extrusion may also be used. The parts of fluid level indicator 270 may have any suitable thickness. Moreover, various portions of the different parts of fluid level indicator 270 may have different thicknesses.

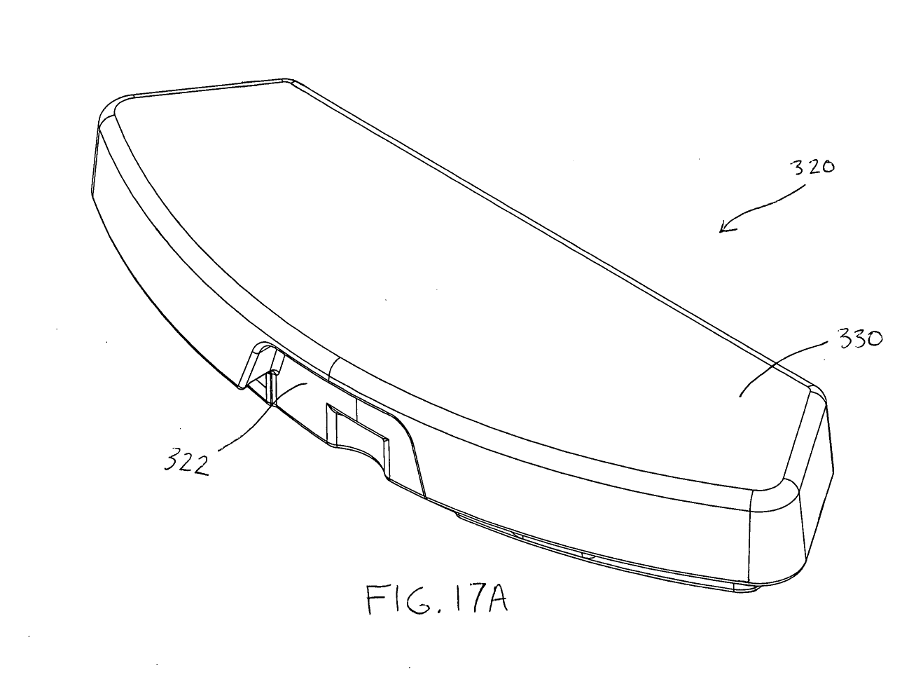

Nourishment dispenser 200 may also include a foam insert configured to be positioned adjacent inner surface 213 of body 210. The foam may serve the function of an insulator, and may separate inner liner 240 from body 210. FIG. 15 shows one acceptable version of such a foam insert. Specifically, FIG. 15 shows foam insert 300, which is shaped substantially like a rectangle. Foam insert 300 may be placed adjacent inner surface 213 of body 210 and, more specifically, between vertically-oriented foam holding recesses 227 and horizontally-oriented foam holding recess 229.

In use, foam insert 300 may be placed adjacent inner surface 213 of body 210, and inner liner 240 may be inserted into body 210 such that the foam insert is positioned between inner liner 240 and body 210. The fit may be snug. The foam insert may keep the parts of nourishment dispenser 200 from rattling around during shipment and sale—the result of which may be to lessen wear and tear on the individual parts. Additionally, the foam insert may serve to insulate the contents of inner liner 240 when nourishment dispenser 200 is used. Additional foam inserts may be used consistent with the present nourishment systems and dispensers, such as between the outside of the front of inner liner 240 and the inside of the front of body 210.

The foam that makes up the present foam inserts may be made from many different materials. Synthetics such as polystyrene (e.g., STYROFOAM material) and polyurethane may be used. Such materials may be purchased off the shelf, and cut to size. Alternatively, they may be injection molded, or formed by extrusion. The foam inserts may have any suitable thickness. Moreover, various portions of the foam inserts may have different thicknesses.

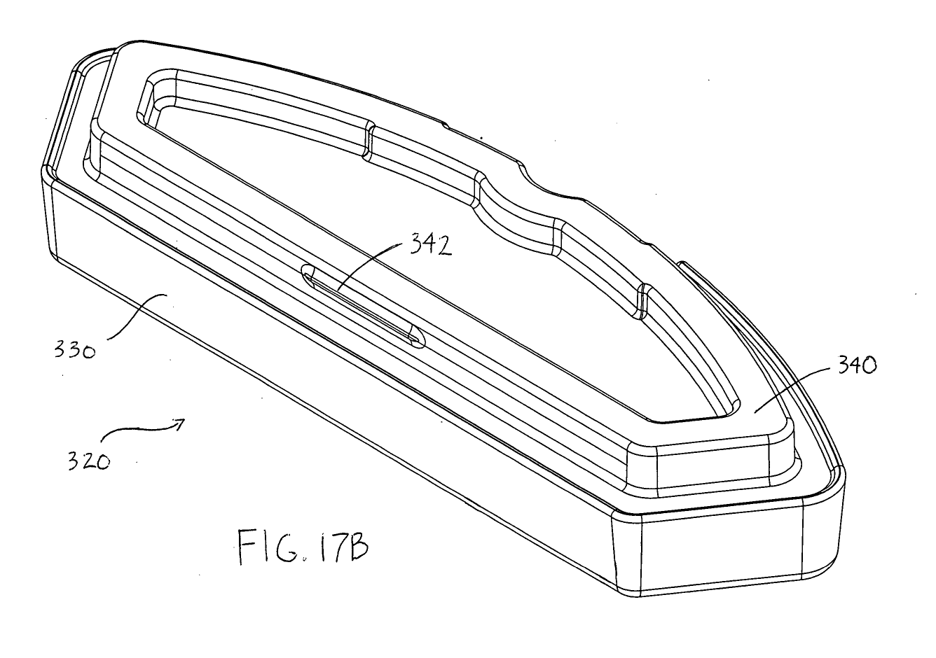

Nourishment dispenser 200 may also include a bracket that is configured to fit within bracket recess 230 in body 210. By a bracket fitting “within” a recess, we mean that a portion of the bracket contacts a portion of the recess. An example of such a bracket is bracket 310 shown in FIG. 16. Bracket 310 may be provided with holes 312 through which screws, nails, bolts, or other sturdy fasteners may be placed in order to couple the bracket to a wall or other structure. Body 210 may then be placed in bracket 310 with or without additional fasteners to further secure the two together.

As shown in FIG. 16, in one embodiment, bracket 310 is formed from a generally round material (the round material may be tubular, or it may be solid) that forms a closed structure. Bracket 310 includes a lower portion 314 (outlined generally with dashed lines), which is configured to fit against the portion of bracket recess 230 provided in the bottom portion of body 210 between legs 219. Legs 219 are useful for balancing nourishment dispenser 200 on bracket 310. Legs 219 also tends to prevent body 210 from rotating away from a vertically-oriented surface on which it can be mounted. Legs 219 also tend to prevent body 210 from tipping forwards or backwards against a vertically-oriented surface on which it can be mounted. Furthermore, legs 219 tend to prevent damage from occurring to the valve assembly that can be part of nourishment dispenser 200. Bracket 310 may also include a cut shown at element 316, which may give the user of the nourishment dispenser some freedom to ensure that bracket 310 is properly mounted. More importantly, cut 316 makes manufacturing bracket 310 easier because welding the bracket together or capping the cut shut would only increase the cost of manufacturing.

The types of material from which bracket recess may be formed include metals and synthetics. For example, metals such as aluminum, stainless steel, or cold roll steel (CRS) may be used, and synthetics such as polyvinyl chloride (PVC) or other sturdy plastics may be used, such as polycarbonate and ABS if they are injection molded.

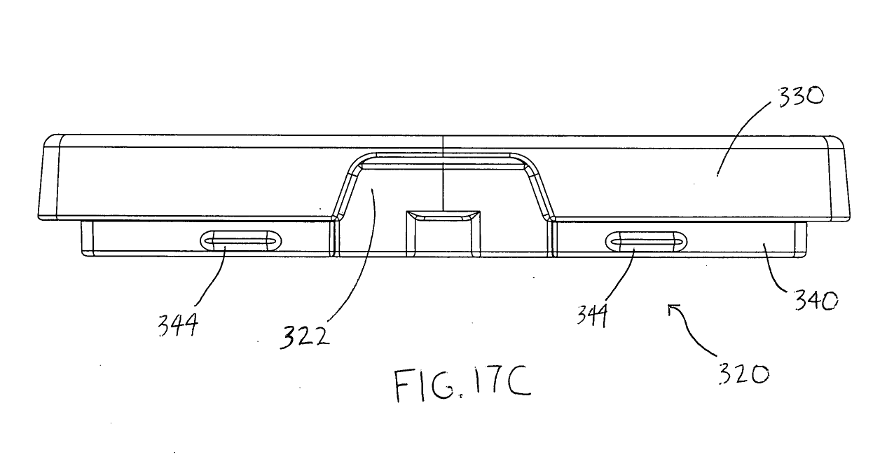

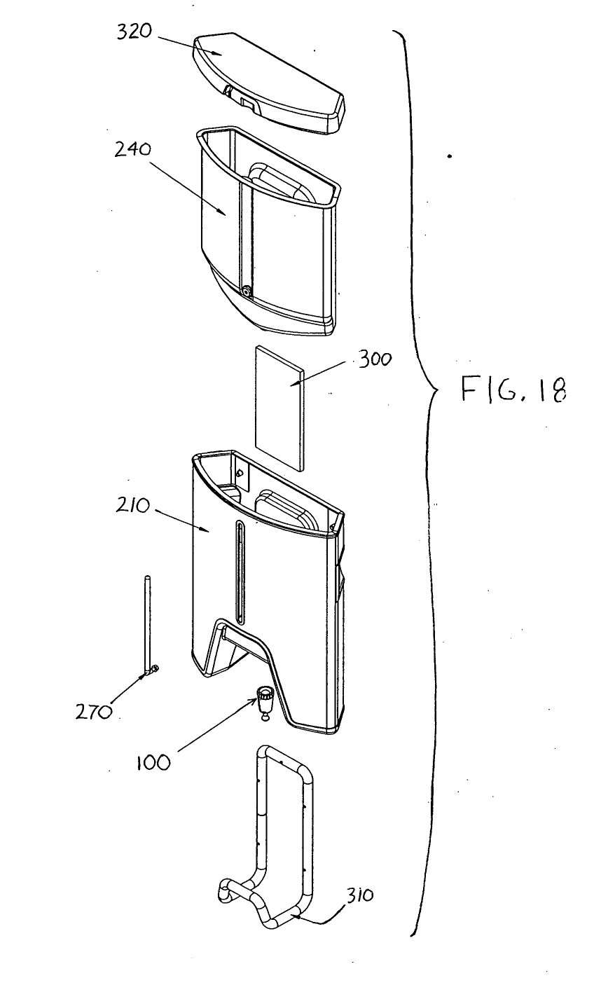

Nourishment dispenser 200 may also be provided with a lid that covers the openings of inner liner 240 and body 210. The lid may serve to keep dirt, debris, and other undesirable elements from falling into inner liner 240 and contaminating its contents. The lid may also serve to further to keep some or all of the contents of inner liner 240 within inner liner 240 should nourishment dispenser 200 be tipped over for any reason. In addition, the lid may serve to insulate the contents of inner liner 240, helping to keep water in inner liner 240 cool, for example. One example of a lid suited for use with nourishment dispenser 200 is shown in FIGS. 17A-17C. FIG. 17A shows a perspective view of lid 320 from the front, top, and right. Lid 320 has top portion 330 and recess 322 in the front of top portion 330. One may place their hand in recess 322 to lift lid 320 off of the top of body 210.

FIG. 17B shows a perspective view of lid 320 from the bottom, back, and left. FIG. 17B shows lower projection 340 of lid 320. Lower projection 340 is configured to fit into the open top of inner liner 240. Lower projection includes a rear securing projection 342, which is useful for helping to ensure that lid 320 fits snugly within the open top of inner liner 240. Inner liner 240 may be configured with a complimentary female indention that fits with rear securing projection 342.

FIG. 17C is a front-view of lid 320, and shows that the lower projection 340 may be configured with front securing projections 344, which serve the same function as rear securing projection 342. Similarly, inner liner 240 may be configured with complimentary female indentions that fit with front securing projections 344.

Lid 320 may be made from any of the same materials that may be used to form body 210 and inner liner 240. Further, the manner in which those materials may be made include the same manufacturing processes described above with respect to body 210.

FIG. 18 is an exploded view, showing how various parts of one embodiment of nourishment dispenser 200 may be put together.

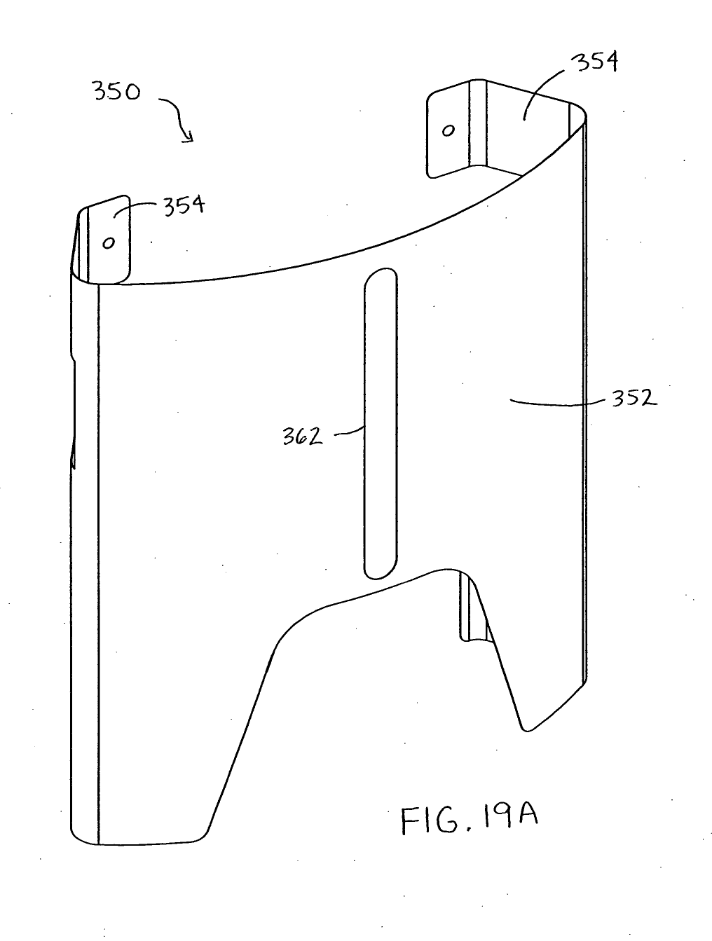

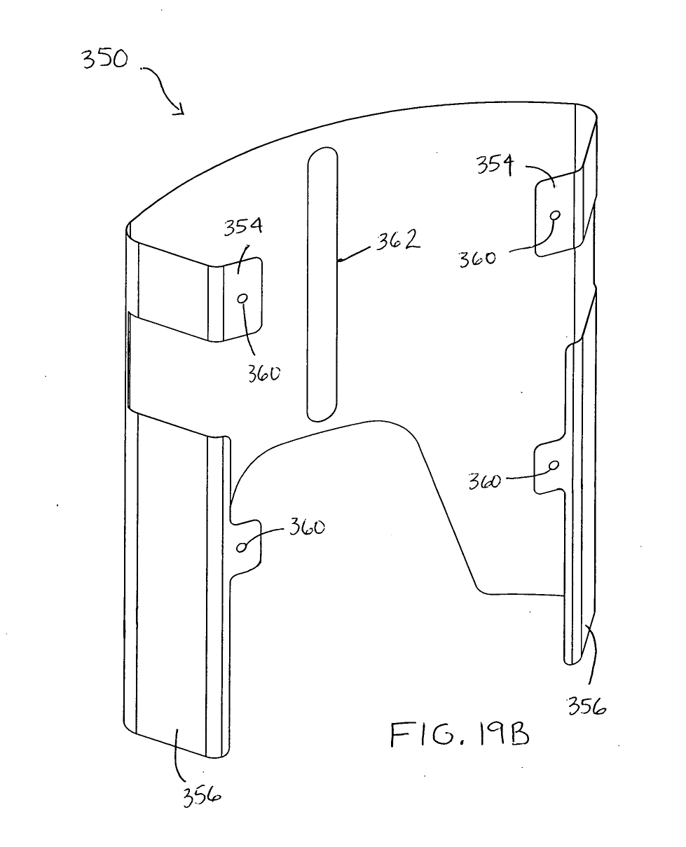

In another embodiment of nourishment dispenser 200, a cover may be coupled to the outer surface of body 210. The cover may be made of metal, such as stainless steel or aluminum. Alternatively, the cover may be made from a polymer, such as a thin sheet of plastic. If reflective, the cover may serve an insulating function by reflecting sunlight and helping to maintain the temperature of the contents of the nourishment dispenser. Further, the cover may add to the aesthetic appeal of the nourishment dispenser. For example, a camouflage pattern may be applied to the cover. One example of a cover suited for attachment to outer surface 212 of body 210 is shown in FIGS. 19A and 19B. Front cover 350 includes front portion 352, upper back arms 354, and lower back arms 356. Holes 360 are provided in upper back arms 354 and lower back arms 356, such that cover 350 can be coupled to body 210. Front portion 352 of cover 350 may be provided with opening 362 through which fluid level indicator 270 may be placed.

Turning back to FIGS. 11A and 11B, which show one example of a body suited for use with one of the present nourishment dispensers—body 210, cover recess 350 is shown. Specifically, body 210 may be provided with body recess 350 that conforms to the shape of cover 330. Further, the back portion of body 210 may be provided with female cover securing receptacles 352, into which bolts or other suitable connectors may be placed to attach cover 330 to body 210. For example, female cover securing receptacles 352 may be provided with at least one thread each, such that threaded bolts or screws may be used to secure cover 330 to body 210.

The individual components described above need not be made in the exact disclosed forms, or combined in the exact disclosed configurations to fall within the scope of the claims and their equivalents. Instead, various substitutions, modifications, additions and/or rearrangements of the features of the inventive systems, valve assemblies, and nourishment systems and dispensers may be made without deviating from their scope, which is defined by the claims and their equivalents.

For example, many different configurations of the body suited for use with the present nourishment dispensers are possible. As further examples, the body and all complimentary parts, such as the inner liner, may be rectangular, round, oval, or triangular (to name a few) in cross-sectional shape when viewed from the top.

The present systems are suited to other modifications as well. For example, instead of providing a housing with a female connector (e.g., by providing at least one thread on the surface of the passageway), at least one thread may be provided on the outer surface of the valve assembly housing. In turn, a female fitting may be provided in an inner liner such that the valve assembly may be attached to the female fitting of the inner liner.

The claims are not to be interpreted as including means-plus- or step-plus-function limitations, unless such a limitation is explicitly recited in a given claim using the phrase(s) “means for” or “step for,” respectively.

The following examples are included to demonstrate embodiments of the present systems. It should be appreciated by those of skill in the art that the configuration of the valve assembly disclosed in the first example and the configuration of the nourishment system disclosed in the second example are exemplary. Those of skill in the art should, in light of this disclosure, appreciate that changes can be made in the specific embodiments described below, and still obtain a like or similar result without departing from the scope of the present systems.

### EXAMPLE 1

A prototype of an embodiment of valve assembly 100 was compared to animal watering valves from two different manufacturers. The “Dog Waterer” (model No. L-100) from Lixit Animal Care Products (100 Coombs Street, Napa Calif. 94558) was tested, as were the “Water Faucet” (Item No. 6655) from Top Paw and distributed by Pacific Coast Distributors Inc. (P.O. Box 84613, Phoenix, Ariz. 85071-4613). These valves were intended by their manufacturers to be used on an outdoor spigot under residential water pressure.

The prototype version of valve assembly 100 shown in FIG. 9 (the prototype) was tested against the Lixit valve and the two Top Paw valves to determine which one provided the best water flow. The four devices were each attached to a test apparatus that simulated the water pressure that would be available from the version of nourishment dispenser 200 shown in FIG. 11. That is, the four device were attached, in turn, to an apparatus that provided a pressure of 12 inches of water.

Specifically, the test apparatus was basically a bucket with a hole cut in the bottom. The prototype valve was then attached to the bucket with a threaded tube. The bucket was filled with water about 12 inches deep to provide the head. The stopwatch was then started and the valve held open with the water draining into a graduated beaker. Once the fluid level reached 300 mL, the stopwatch was stopped and the valve was closed. Since the fluid height was read by eye, there was likely a tolerance of about 20 mL between readings. Flow rate was then calculated by taking 300 mL and dividing by the elapsed time.

The results of the 6 trials of the test appear below in Table 1. The times listed are in the format minutes:seconds. Certain valves were tested with fewer trials than others.

TABLE 1

| Trial | Lixit valve | Top Paw valve 1 | Top Paw valve 2 | Prototype |
|---|---|---|---|---|
| 1 | 02:16 | 01:11 | 01:03 | 00:25 |
| 2 | 02:17 | 01:08 | 01:50 | 00:24 |
| 3 | — | 01:30 | 01:08 | 00:26 |
| 4 | — | 01:22 | 01:00 | 00:27 |
| 5 | — | 01:10 | 01:00 | — |
| 6 | — | 01:07 | — | — |
| Average | 02:16 | 01:15 | 01:12 | 00:26 |

The Lixit valve performed poorly. Its design included a baffle to restrict flow under high water pressures. The Top Paw valve performed reasonably well. Neither the Lixit valve nor the Top Paw valves provided flow delivery that was consistent. This may have been due at least in part to the fact that the valve stems of these valves were usually biased away from center. Triggering the valve stems of these commercial valves achieved different amounts of flow.

The prototype achieved better than twice the flow rate of the Top Paw valve (i.e., it took more than twice as long for the same volume of fluid to exit the Top Paw valves as compared to the prototype) and better than four times the flow rate of the Lixit valve. Further, the flow of the prototype was substantially consistent regardless of the direction that valve stem was triggered. Additionally, the valve stem of the prototype consistently returned to center after being triggered. This was due at least in part, we believe, to the ridges provided along a portion of the stem, as shown in FIG. 4, for example, and at least in part to the formation of a gap between the housing shoulder washer and gasket arrangement of the prototype, as discussed above with respect to FIGS. 7B-7D.

### EXAMPLE 2

Appendix 1 contains a set of installation instructions and dimensions that may be used to construct one embodiment of the present nourishment systems. The sheet in the appendix showing the exploded view of one embodiment of nourishment system 200 shows, the enlarged view of the detail showing the coupling between fluid level indicator 270 and body 210 and inner liner 240 illustrates that a gasket 400 and a washer 410 may be used to help make that coupling connection.

1. A valve assembly comprising:
a valve stem;
a baffle having an opening that is configured to fit over a portion of the valve stem; and
a structure positioned near the baffle and oriented in a fixed position with respect to the valve stem that is substantially perpendicular to the valve stem;
where when the valve stem is biased in a sideways fashion, the baffle contacts the structure;
where the valve assembly is configured for attachment to a nourishment dispenser that provides nourishment to animals.

2. The valve assembly of claim 1, further including a biasing structure positioned near the baffle, the baffle being a washer.

3. The valve assembly of claim 2, where the structure is a gasket.

4. The valve assembly of claim 3, where the baffle is a washer.

5. A valve assembly comprising:
a valve stem;
a baffle having a top surface and an opening that is configured to fit over a portion of the valve stem; and
a structure having a bottom surface, the structure being positioned such that when the valve stem is biased in a sideways fashion, the baffle contacts the structure and a gap forms between the top surface of the baffle and the bottom surface of the structure;
the gap having a length and a height that varies along the length;
a portion of the height having a value of at least 0.012 centimeters when the valve stem is biased in a sideways fashion by one degree;
where the valve assembly is configured for attachment to a nourishment dispenser that provides nourishment to animals.

6. The valve assembly of claim 5, where a portion of the height has a value of at least 0.12 centimeters when the valve stem is biased in a sideways fashion by seven degrees.

7. The valve assembly of claim 5, where a portion of the height has a value of at least 0.024 centimeters when the valve stem is biased in a sideways fashion by one degree.

8. A system comprising:
a valve assembly that includes:
a housing;
a valve stem coupled to the housing; and
an axis running through the valve stem;
the valve stem including a section having a groove that includes a portion oriented at less than 85 degrees to the axis.

9. The system of claim 8, where the section includes multiple grooves.

10. The system of claim 9, where one of the grooves is bordered by ridges.

11. The system of claim 8, where the housing includes a first end, a second end, a passageway, a housing shoulder extending into the passageway, and at least one thread positioned between the housing shoulder and the first end of the housing.

12. The system of claim 11, where the valve stem has a first end, an outwardly projecting shoulder positioned near the section, a second end, and a threaded recess extending from the first end of the valve stem, into the valve stem, and toward the second end of the valve stem.

13. The system of claim 12 also comprising a gasket configured to fit within the housing between the housing shoulder and the first end of the housing, the gasket having a screen.

14. The system of claim 8 also comprising:
a nourishment dispenser for animals that includes:
a body.

15. The system of claim 14, where the body has a bracket recess.

16. The system of claim 15, where the nourishment dispenser also includes:
a bracket configured to be positioned in the bracket recess.

17. The system of claim 14, where the body has an inner surface, and the nourishment dispenser also includes:
a foam insert positioned adjacent the inner surface of the body.

18. The system of claim 17, where the nourishment dispenser also includes:
an inner liner positioned adjacent the foam insert, the inner liner having a valve assembly male fitting configured for attachment to the valve assembly.

19. The system of claim 18, where the body has an opening, and the nourishment dispenser also includes:
a lid configured to cover the opening.

20. The system of claim 18, where the nourishment dispenser also includes:
a fluid level indicator having a projection coupled to the inner liner.

21. The system of claim 20, where the body has an outer surface, and the nourishment dispenser also includes:
a cover coupled to the outer surface of the body.

22. The system of claim 8 also comprising:
a nourishment dispenser for animals that includes:
a hose having an end configured to be coupled to the valve assembly.

23. The system of claim 22 also comprising:
a nourishment dispenser holder configured to secure the hose to a surface.

24. A nourishment system comprising:
a nourishment dispenser for animals that includes:
a body; and
a fluid level indicator coupled to the body, the fluid level indicator having
a first opening, a second opening, and a passageway extending from the first opening to the second opening.

25. The nourishment system of claim 24, where the body also has a bracket recess.

26. The nourishment system of claim 25, where the nourishment dispenser also includes:
a bracket configured to be positioned in the bracket recess.

27. The nourishment system of claim 24, where the body has an inner surface, and the nourishment dispenser also includes:
a foam insert positioned adjacent the inner surface of the body.

28. The nourishment system of claim 27, where the nourishment dispenser also includes:
an inner liner coupled to the body and positioned adjacent the foam insert, the inner liner having a valve assembly male fitting configured to be coupled to a valve assembly.

29. The nourishment system of claim 28, where the body has an opening, and the nourishment dispenser also includes:
a lid configured to cover the opening.

30. The nourishment system of claim 28, where the fluid level indicator is coupled to the inner liner.

31. The nourishment system of claim 30, where the body has an outer surface, and the nourishment dispenser also includes:
a cover coupled to the outer surface of the body.

32. The nourishment system of claim 24, where the nourishment system also includes:
a valve assembly configured to be coupled to the body, the valve assembly including:
a housing;
a valve stem coupled to the housing; and
an axis running through the valve stem;
the valve stem including a section having a groove that includes a portion oriented at less than 85 degrees to the axis.

33. A nourishment system comprising:
a nourishment dispenser for animals that includes:
a body having a nourishment holding portion and two legs extending from the nourishment holding portion.

34. The nourishment system of claim 33, where the nourishment dispenser also includes:
a fluid level indicator coupled to the body, the fluid level indicator having
a first opening, a second opening, and a passageway extending from the first opening to the second opening.

35. The nourishment system of claim 33, where the body also has a bracket recess.

36. The nourishment system of claim 35, where the nourishment dispenser also includes:
a bracket configured to be positioned in the bracket recess.

37. The nourishment system of claim 34, where the body has an inner surface, and the nourishment dispenser also includes:
a foam insert positioned adjacent the inner surface of the body.

38. The nourishment system of claim 37, where the nourishment dispenser also includes:
an inner liner positioned adjacent the foam insert, the inner liner having a valve assembly male fitting configured to be coupled to a valve assembly.

39. The nourishment system of claim 38, where the body has an opening, and the nourishment dispenser also includes:
a lid configured to cover the opening.

40. The nourishment system of claim 38, where the fluid level indicator is coupled to the inner liner.

41. The nourishment system of claim 40, where the body has an outer surface, and the nourishment dispenser also includes:
a cover coupled to the outer surface of the body.

42. The nourishment system of claim 33, where the nourishment system also includes:
a valve assembly configured to be coupled to the body, the valve assembly including:
a housing;
a valve stem coupled to the housing; and
an axis running through the valve stem;
the valve stem including a section having a groove that includes a portion oriented at less than 85 degrees to the axis.

43. A nourishment system comprising:
a nourishment dispenser for animals that includes:
a body having an inner surface;
an inner liner coupled to the body; and
a valve assembly coupled to the body and to the inner liner, the valve assembly including a valve stem.

44. The nourishment system of claim 43, where the nourishment dispenser also includes:
a fluid level indicator coupled to the body, the fluid level indicator having
a first opening, a second opening, and a passageway extending from the first opening to the second opening.

45. The nourishment system of claim 43, where the body also has a bracket recess.

46. The nourishment system of claim 45, where the nourishment dispenser also includes:
a bracket configured to be positioned in the bracket recess.

47. The nourishment system of claim 43, where the nourishment dispenser also includes:
a foam insert positioned between the inner liner and the body.

48. The nourishment system of claim 43, where the inner liner has a valve assembly male fitting configured to be coupled to a valve assembly.

49. The nourishment system of claim 43, where the body has an opening, and the nourishment dispenser also includes:
a lid configured to cover the opening.

50. The nourishment system of claim 43, where the body has an outer surface, and the nourishment dispenser also includes:
a cover coupled to the outer surface of the body.

51. The nourishment system of claim 43, where the valve assembly includes:
a housing, and the valve stem is coupled to the housing; and
an axis running through the valve stem;
the valve stem including a section having a groove that includes a portion oriented at less than 85 degrees to the axis.
